(19) United States
(12) Patent Application Publication
(10) Pub. No.: US 2015/0153476 A1
(43) Pub. Date: Jun. 4, 2015

(54) METHOD FOR CONSTRAINED HISTORY MATCHING COUPLED WITH OPTIMIZATION

(71) Applicant: Schlumberger Technology Corporation, Sugar Land, TX (US)

(72) Inventors: Michael David Prange, Somerville, MA (US); Thomas Dombrowsky, Reading (GB); William J. Bailey, Somerville, MA (US)

(73) Assignee: SCHLUMBERGER TECHNOLOGY CORPORATION, Sugarland, TX (US)

(21) Appl. No.: 14/371,767

(22) PCT Filed: Jan. 11, 2013
(86) PCT No.: PCT/US2013/021249

§ 371 Date: Jul. 11, 2014

Related U.S. Application Data
(60) Provisional application No. 61/585,940, filed on Jan. 12, 2012.

(51) Int. Cl. G01V 99/00; G06F 17/10; G06F 17/50

(52) U.S. Cl. CPC G01V 99/005; G06F 17/5009; G06F 17/10

(57) ABSTRACT

Apparatus and methods for hydrocarbon reservoir characterization and recovery including collecting geological data relating to a subteranean formation, forming initial parameters using the data, performing a pricipal component analysis of the parameters to create a model, and performing history matching using the model. In some embodiments, the principal component analysis is linear principal component analysis or kernal principal component analysis.

### PRIORITY CLAIM

This application claims priority to U.S. Provisional Patent Application Ser. No. 61/585,940, filed with the same title on Jan. 12, 2012, which is incorporated by reference herein.

### FIELD

Embodiments described herein relate to methods and apparatus to characterize and recover hydrocarbons from a subterranean formation. Some embodiments relate to mathematical procedures utilizing history matching analysis and principal component analysis.

### BACKGROUND

History matching a reservoir model involves calibrating the model such that historical field production and pressures are brought into close agreement with calculated values. The primary purpose of such efforts is to provide better forecasts that may be used to guide future production and field development decisions. Better models can be expected to guide decision makers toward better field planning decisions.

A typical history-matching approach is illustrated in FIG. 1 (prior art). The asset team gathers prior information from well logs and seismic data and combines this with geological interpretations in order to create a simulation model. Considerable uncertainty exists in this model. Sometimes this uncertainty is expressed as a set of equiprobable models satisfying the prior information. The reservoir engineer is then tasked with history-matching the reservoir model. Since the history matching is time consuming, it is common to work with a ‘typical’ member of the set of uncertainty models (perhaps the median model), though it is sometimes possible to history match a few of the end members of the set in order to capture a range of reservoir forecast outcomes. The model to be history matched is then processed by a reservoir simulator to predict pressures and flows that are then matched with historical data from the reservoir. If the match is not satisfactory, the parameters of the simulation model are adjusted and re-simulated until a satisfactory match is achieved.

FIG. 1 (Prior Art) illustrates that the typical history-matching process starts with a simulation model that is built from prior information, including geology, well log and seismic inputs. This model is then processed by a reservoir simulator to produce simulated pressures and flows that are then matched with historical data from the reservoir. If the match is not satisfactory, the simulation model is adjusted and re-simulated until a satisfactory match is achieved.

There exists a multitude of computer-aided history-matching tools to aid the reservoir engineer. An example of one such tool is the SimOpt™ application. SimOpt™ is a Schlumberger Technology Corporation product commercially available in Sugar Land, Tex. that assists the reservoir engineer in the history-matching of ECLIPSE™ simulation models. With SimOpt™, the sensitivities of simulation results are computed with respect to a subset of model parameters, and these are used to quickly identify the key parameters to focus on in the history-matching process. These parameters may then be updated automatically or manually in an iterative process. However, in order for these approaches to be useful, the original model parameters (e.g., individual values of porosity and permeabilities for each model grid cell), which may number into the hundreds of thousands, or even millions, must be expressed in terms of a smaller set of control parameters that are used to manipulate the original model parameters. It is common to assign these controls as block multipliers, each of which is applied as a scalar multiplication on a region of model parameters, such as region of permeability or porosity values for which it makes geological sense to manipulate as a block. A shortcoming of this approach is that the updated model may no longer fit within the uncertainty range of the original prior model. While the updated model may now better fit the historical field values, it will most likely sacrifice the goodness-of-fit to the prior measurements in order to do so. In order for a model to be more reliable for reservoir forecasting, it should provide a reasonable fit to all available information, including both the available measurements and the prior uncertainty on the model.

The history-matching process is an ill-posed optimization problem in that many models often satisfy the production data equally well. One approach in obtaining a more predictive reservoir model is to further constrain the history-matching process with all available ancillary data, such as well logs, seismic images and geological constraints. Thus, changes to the model by the optimizer will automatically conform to all available reservoir information. Since the ancillary data provides many additional constraints that must be satisfied by the optimization solution, the number of degrees of freedom available for manipulation by the optimizer is considerably reduced. This reduced set of control variables that express the true degrees of freedom available to the optimizer are the ‘latent variables’ of the system.

### SUMMARY

Embodiments disclosed herein relate to apparatus and methods for hydrocarbon reservoir characterization and recovery including collecting geological data relating to a subteranean formation, forming initial parameters using the data, performing a pricipal component analysis of the parameters to create a model, and performing history matching using the model. In some embodiments, the principal component analysis is linear principal component analysis or kernal principal component analysis.

### FIGURES

FIG. 1 (prior art) is a flowchart of a method for analyzing geological information.

FIG. 2 is a flow chart illustrating a method for analyzing geological information including using principal component analysis and history matching.

FIG. 3 is a flow chart including processes for analzying subterranean formation data using principal component analysis and history matching.

FIGS. 4(a) and 4(b) are model parameters as a function of each other in two dimensional space and in and in 1 dimensional latent space mapped back into model space respectively.

FIGS. 5(a), 5(b), 5(c), and 5(d) include (a) an example mutlinormal sample, (b) a sample represented by 50 principal components, (c) a sample represented by 20 principal components, and (d) retained variance fraction as a function of latent dimension.

FIGS. 6(a) and 6(b) illustrate a parabolic and spiral distribution, respectively.

FIG. 7 is Brugge information content as a function fo the number of principal components.

FIG. 8 is an aerial view of the Brugge field.

FIG. 9 is an history-matching optimization convergence versus iteration number.

FIG. 10 is summary data in multiple chart form.

FIG. 11 is an aerial view of the Schelde formation (Layer 1).

FIG. 12 is an aerial view of the Maas formation (Layer 3).

FIG. 13 includes plots of FIG. 6 samples in 1D latent space.

FIG. 14 includes maps of FIG. 6 samples in 1D latent space projected back into original 2D model space.

FIG. 15 includes plots for three values of K of FIG. 6 samples.

FIGS. 16(a) and 16(b) are plots of normallized retained variance fractions for a parabolic distribution and spiral distribution respectively.

FIGS. 17(a) and 17(b) are plots of normalized graph dimeter as a function of K for a parabolic distribution and spiral distribution respectively.

FIG. 18 is a plot of normalized graph of diameter as a function of K.

FIGS. 19(a) and 19(b) are plots of normalized graph of diameter as a function of K for samples from a unit cube and an elongated cube respectively.

FIG. 20 is a plot of retained variance fraction as a function of reduced model dimension.

FIG. 21 is a series of models constructed from kPCA for values of K corresponding to FIG. 20's legend.

FIG. 22 is a series of samples from a set of channel models.

FIG. 23 is a plot of graph diameter as function of K.

FIG. 24 is a plot of the retained variance fraction as a function of reduced model dimension.

FIG. 25 is a series of channel models.

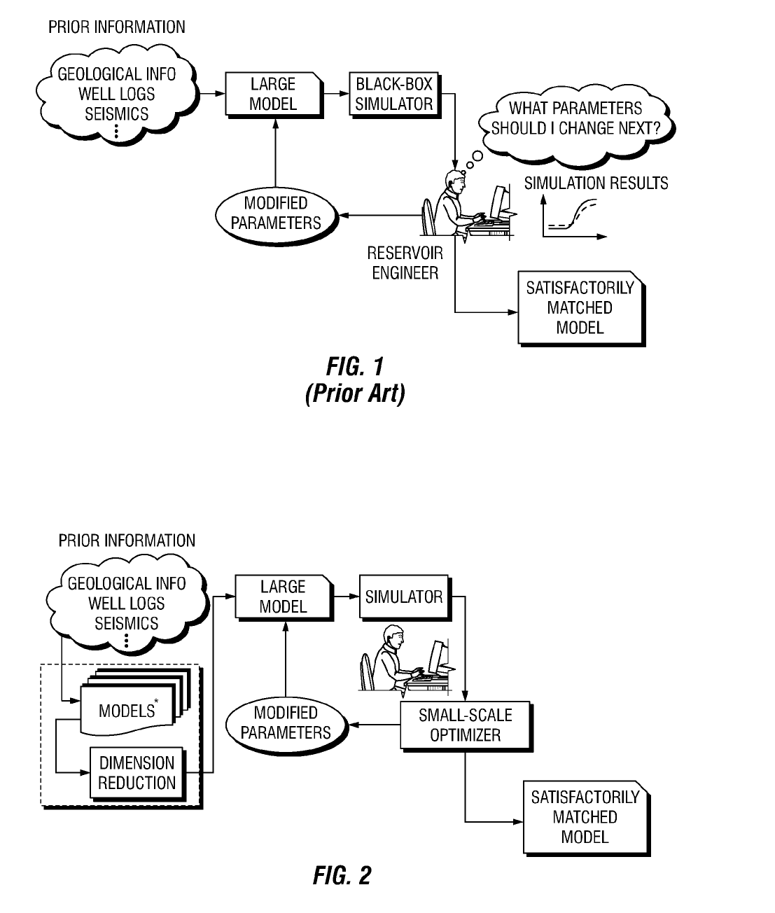

### DETAILED DESCRIPTION

As an initial matter, geostatistics is concerned with generating rock properties for the entire model volume from the fine-scale information available at the wellbore, including rock make-up (fractions of sand, shale and other rock types), and porosity and permeability (possibly averaged). This information, together with knowledge about depositional environment and studies from surface rock (analogues) is used to generate a statistical description of the rock. Statistical methods such as Sequential Gaussian Simulation (SGS) can then be used to generate property fields throughout the reservoir, resulting in multiple equi-probable realizations of the reservoir model that all satisfy the geological assumptions.

Generally, in applied mathematics, the replacement of a large-scale system by one of substantially lower dimension (that has nearly the same response characteristics) is called ‘model reduction.’ Unfortunately, most of this literature assumes that one has access to the fundamental partial differiental equations controlling the simulation process. It is more typical in reservoir simulation applications that the simulator is a complex combination of many simulation processes that are not simply expressed by a small set of equations suitable for analysis. We avoid this complexity by treating these simulators as ‘black-box’ processes that convert simulation input files into reservoir predictions.

FIG. 2 illustrates a history-matching workflow in which dimension reduction is achieved by identifying the latent variables from the prior model uncertainty. History matching is then performed using these latent variables as the control variables. In this approach, reservoir uncertainty is expressed in terms of a set of equiprobable reservoir models. These models are analyzed to extract the latent variables of the system, plus a mapping that transforms the latent coordinates back into the original model space. This mapping allows the optimizer to work in a smaller latent space, while the black-box simulator continues to work with models in the original model space.

In more detail, we describe a history-matching process in which dimension reduction is used to simplify the search space. The latent variables are first identified from a set of equiprobable prior reservoir models. Dimension reduction is associated with a reverse mapping that transforms the latent model coordinates back to the original model space. This allows the optimizer to work in the reduced, latent space while the black-box simulator is allowed to work with models in the original model space.

Embodiments of the invention relate to a history-matching (HM) workflow based on linear Principal Component Analysis (PCA). Principal Component Analysis comes in various forms including extensions of the IsoMap algorithm, such as linear and nonlinear (which is often referred to as kernal-based or kPCA). Herein, we refer to PCA, linear PCA, and/or kPCA as appropriate. Our methodology allows a priori assumptions about the geology of the subsurface to be used to constrain the history-matching problem. This means that the history-matched model not only satisfies the historical data, but it also conforms to the constraints imposed by the geological setting. Often in HM optimization, such geological constraints are ignored for lack of an efficient mechanism for imposing them. Our PCA approach provides a simple and efficient means for imposing these constraints, under an approximation, when the prior model uncertainty is expressed as a collection of possible geological realizations. The resulting history-matched model adheres to the available geological information. We demonstrate its efficacy by comparison with previously published results.

Furthermore, the PCA methodology provides a framework to evaluate the uncertainty in the history-matched result, thus providing a firm basis for uncertainty-based production forecasting. This mapping limits the search space to geologically reasonable models, and the models resulting from the history-matching process are thus guaranteed to match both the geological constraints as well as the observed data. Furthermore, the reduced number of variables in the new model parametrization makes it feasible to use automated optimization algorithms.

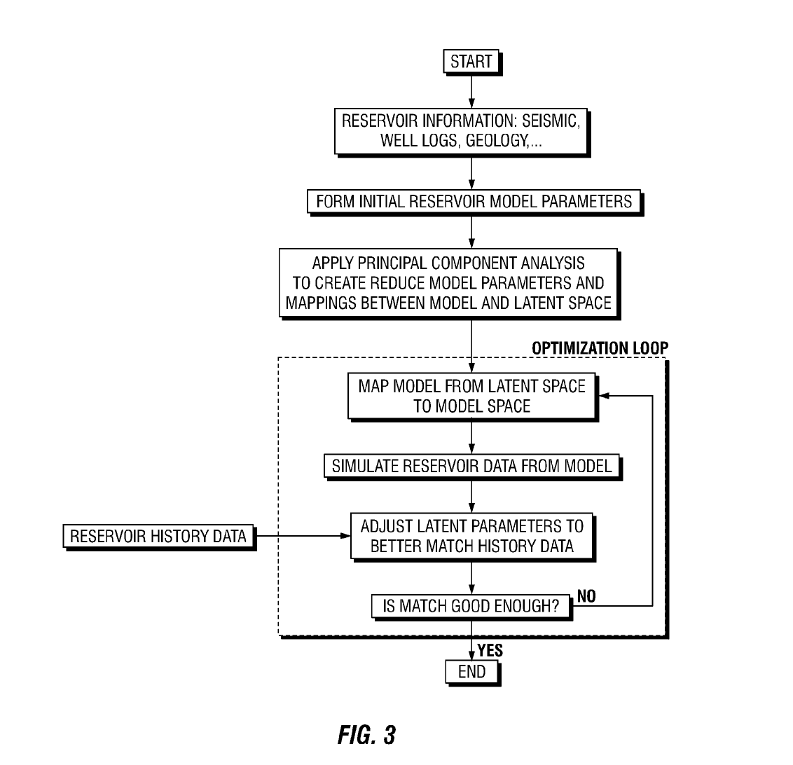

FIG. 3 provides a flow chart of one embodiment of the methods discussed herein. Initially, subteranean formation data is collected, including data from seismic, geologic, nuclear magnetic resonance, and/or other testing methods. Next, multiple realizations of the data are used to form initial reservoir model parameters. Then, PCA is performed to create reduced model parameters and mappings between the model and latent space. Finally, the reservoir model is optimized using the reduced set of control variables to fit the historical data.

This is accomplished via an optimization loop. First we map a model from latent space to model space. Next, we simulate reservoir data from the model. Then, reservoir history data is introduced and we adjust the latent parameters to better match history data. We determine if the history match is good enough, if the difference between the history data and reservoir data is below a threshold. If it is not, additional optimization continues. If it is, then no additional optimization occurs.

More simply, embodiments relate to collecting geological data relating to a subteranean formation, forming initial parameters using the data, performing a pricipal component analysis of the parameters to create a model, and performing history matching using the model. In some embodiments, the data includes geology, well log(s), seismic information and/or a combination thereof.

In some embodiments, the principal component analysis is linear principal component analysis or kernal principal component analysis. In some embodiments, the principal component analysis may include a reduced dimensional parameter space, identify the latent variables of the uncertainty, and/or create a set of latent variables that map onto the initial model parameters. In some embodiments, the history matching may include an automated search of the feature space, an analysis of the uncertainty of the history-matched model, and/or a gradient-based optimization algorithm.

Some embodiments will include introducing an oil field service to the formation such as reservoir management, drilling, completions, perforating, hydraulic fracturing, water-flooding, enhanced and unconcentional hydrocarbon recovery, tertiary recovery, or a combination thereof. In some embodiments, optimization occurs in a reduced control parameter space than if no principal component analysis occurred.

The model reduction in PCA is least-squares optimal for a linear system. This yields optimal solutions for models with simple geostatistics, in particular those created with Sequential Gaussian Simulation (SGS) or Kriging. However, complex geostatistical priors may also be used, but the resulting models will only be approximately correct with respect to the geological constraints. A possible extension to linear PCA is the so-called kernel-based (or simply kernel) Principal Component Analysis (kPCA, with lower-case “k”). kPCA introduces non-linearity into the feature space mapping and, in doing so, may help to represent data with higher-order statistics more accurately.

Herein, we consider two approaches for deducing the latent variables from the prior model uncertainty: principal component analysis (PCA) and kernel PCA (kPCA). PCA is a linear approach in that it identifies a reduced set of latent variables that are linearly related to the model variables. This is appropriate when the prior model uncertainty is adequately described by a multinormal distribution, i.e., by a mean vector and a covariance matrix. This is true for prior models that are generated by standard geostatistical tools such as sequential Gaussian simulation. PCA is also appropriate for prior model uncertainties that can be adequately transformed into new random variables that are themselves multinormal, with the caveat that this transformation should be applied to the model before PCA is performed. kPCA is a nonlinear extension of PCA that is useful when the prior model uncertainty goes beyond multinormality, such as when multi-point or object-based geostatistical methods were used to generate the models. By including nonlinearity, kPCA preserves more of the higher-order moment information present in the prior uncertainty.

PCA has demonstrated its usefulness in dimension reduction for history matching when the prior model uncertainty is well approximated by a multinormal distribution (the linear problem). Here, we examined a possible extension of PCA into the nonlinear domain using a kernel-based extension of the IsoMap algorithm, which has seen wide use in machine learning. We denote our kernel-based extension of IsoMap as kPCA. The kPCA algorithm forms a graph with the model samples as nodes, and with the edges joining each model to its K nearest neighbors. In the limit of K being the number of model samples, kPCA is entirely equivalent to PCA. The lower limit of K is the value at which the graph becomes disconnected. Thus, K serves as a tuning parameter that controls the amount of nonlinearity supported in the analysis. This neighborhood locality also provided the solution to the so-called ‘pre-image problem’, i.e., the issue of mapping a latent-space point back into the model space, by providing a solution involving the preservation of a local isomorphism between the latent and model spaces.

Both PCA and kPCA provide an L₂-optimal mechanism for reducing high-dimension model spaces to much lower-dimensional latent spaces. The possibly complex distributions in the model space are simplified to unit multinormal distributions in the latent space, making it easy both to create new model samples that are consistent, in some sense, with the prior model distribution, and to explicitly write the latent-space distribution for use as the prior term in a Bayesian objective function. In the case of PCA, the meaning of consistency is that the first and second moments of the prior distribution are preserved when samples from the latent space are mapped back into the model space. This consistency also applies to any conditioning based on well data, seismic data, and inferred geological trends. In order to demonstrate that this consistency extends to the nonlinear extensions of kPCA, metrics would need to be developed that would compare, for example, higher-order moments of the training samples with samples mapped back from feature space, the subject of future work. In lieu of this, here we compared training images with images sampled from feature space to show the strengths and weaknesses of the mapping. These results indicate that the correct choice of K is an important and unresolved issue.

We explored the robustness of kPCA on two highly nonlinear 2D models: a parabolic model and a spiral model, more detail is provided below. The optimal choice for K was the largest value before edges were created between distant points on the manifold, i.e., before short circuiting occurred. A good measure of short circuiting was found to be the normalized graph diameter, with each abrupt drop in graph diameter indicating a new short-circuiting edge. Two image-based examples were considered in 10⁴-dimensions: a multinormal model and a channel model. These demonstrated that normalized graph diameter was not a useful metric for choosing K. This was particularly apparent in the channel model example, where K=100 seemed optimal based on graph diameter, while K=2 was the best choice based on the sample images mapped back from latent space. It may be that graph diameter is a poor guide for the choice of K in high-dimensional model spaces because short circuiting is not the key determining factor when such spaces are poorly sampled.

In the following, we present a review of PCA as it relates to model reduction for history matching. We then show how PCA can be extended to nonlinear problems through the use of kernel methods. We demonstrate kPCA first on 2D examples in order to build intuition, and then apply it to 100×100 grid cell models to demonstrate its robustness.

Dimension Reduction using PCA

One approach to discovering the latent variables in a system is called principal component analysis (PCA). PCA is also known by other names: Karhunen-Loève transform, Hotelling transform, proper orthogonal decomposition and classical multidimensional scaling. The latter is actually different in form and origin to PCA, but is equivalent. We make use of this connection between PCA and multidimensional scaling in the section on kemal-based PCA to extend PCA to nonlinear analysis. We have demonstrated the effectiveness of PCA in history-matching and forecast optimization on the Brugge standard model.

In PCA, model uncertainty is represented by a set of models that are sampled from the model uncertainty distribution. This set of models may also be a collection created by experts to describe the range of valid models, with the caveat that these represent the statistics of the uncertainty as well as the range. For example, if only minimum, median, and maximum models are given, then each will be assumed to be equally likely. Each model is expressed as a vector, mᵢ, where i is the model index, and the collection of N models is gathered into the columns of matrix M=[m₁, . . . , m_{N}]. If these models are sampled from a multinormal distribution, then the model uncertainty is completely described by a mean vector, μ, and a covariance matrix, Σ. Although the true values of μ and Σ are typically unknown, their values are approximated from the model samples by μ=M1/N and Σ=(M−μ1^{T})(M−μ1^{T})^{T}/N, where 1 is the vector of ones. If the models are not sampled from a multinormal distribution, then μ and E approximate the first and second moments of that distribution.

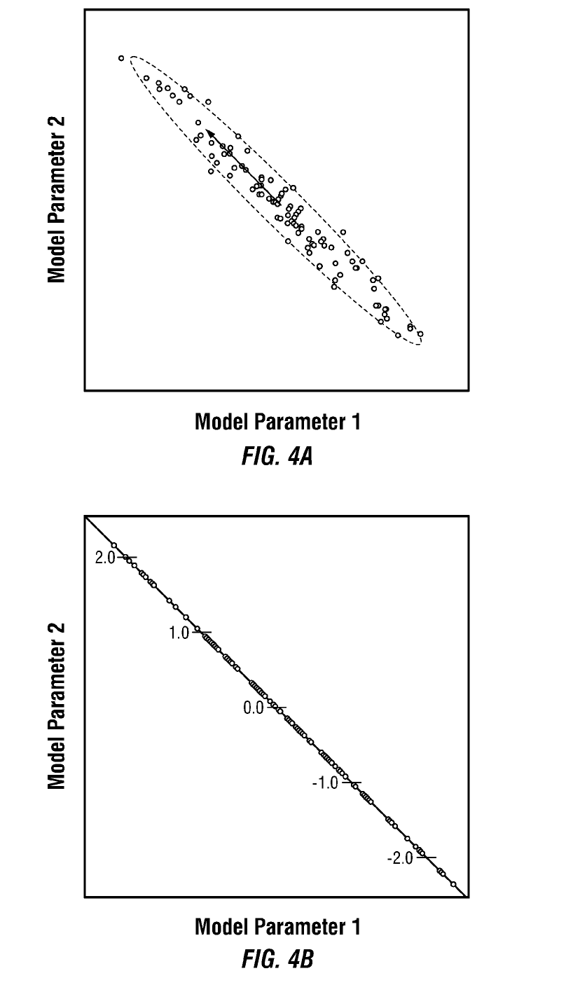

The PCA approach is illustrated in a two-dimensional example in FIG. 4(a). The points represent 100 two-parameter models, all sampled from a multinormal distribution. These points represent the uncertainty in the prior model. Just as the uncertainty in the parameter of a one-dimensional model could be illustrated by error bars (indicating the region of one less than standard deviation from the mean), this region in a two-dimensional model has the shape of an ellipse, indicated by the dashed curve denoting the region within which \sqrt{(m−μ)^{T}Σ⁻¹(m−μ)}<2. In three dimensions, this region would be enclosed by an ellipsoid, and it would be a hyper-ellipsoid in more than three dimensions. The axes of this ellipse indicate the directions of maximum and minimum uncertainty. The principal axes of the ellipse are given by the eigenvectors of Σ, u₁ and u₂, and the one-standard-deviation lengths along these axes are given by the corresponding eigenvalues, λ₁ and λ₂. These eigensolutions are traditionally labeled such that λ₁≧ . . . ≧λ_{N}. Note that λᵢ=0 for i>N.

In PCA, a new coordinate system is defined that is aligned with these principal axes of uncertainty. This is called the “feature space”. To obtain this new coordinate system, the original model coordinate system is: 1) translated to obtain a zero mean, 2) rotated to align with the principal axes of the uncertainty ellipse, making the point uncorrelated in the feature space, and 3) scaled so that the points have unit variance in the feature space.

In the feature-space coordinates, model reduction is accomplished by eliminating coordinates with insignificant uncertainty. This is illustrated in FIG. 4(b), where a reduced, one dimensional, feature-space coordinate system is shown projected back into the original coordinate system as a gray line. This line is simply the long axis of the ellipse. The model points have been orthogonally projected onto this line, and may thus be expressed by a single coordinate value. The fractional reduction in total variance due to this model reduction is simply expressed as λ₂²/(λ₁²+λ₂²)=0.0091, in this case, where the λᵢ² are the principal variances found from the samples in FIG. 4(a).

This reduced feature space is called the latent space. The dimensions of this reduced coordinate system corresponds to the degrees of freedom in the prior uncertainty model that are available for manipulation by the optimizer in order to solve the history-matching problem while remaining consistent with the prior information. These are the latent variables in the system.

In general, the PCA approach proceeds by identifying the principal axes and principal lengths from the eigen decomposition of Σ. Once the directions of insignificant uncertainty have been identified, the models are orthogonally projected into the subspace of the remaining principal directions. There is a linear mapping that allows models to be projected into the reduced space, and another linear mapping that projects reduced-space models back into a subspace of the original model space. When reduced-space models are projected back into the original model space, their uncertainty along the excluded principal directions is zero, but this lack of fidelity is small if the elimination directions were chosen such that the total loss of variance is small.

Principal component analysis is briefly outlined here in order to estabish concepts and introduce notation. In PCA, model uncertainty is represented by a set of models that are samples from the distribution of model uncertainty. Each of these models is expressed as a vector, mᵢ, where i is the index of each model, and the collection of N uncertainty models are gathered into the columns of a matrix, M=[m₁, . . . , m_{N}]. Traditional PCA finds the principal directions and principal values of the models from the sample covariance of M, given by

$$Σ = \frac{1}{N} ( MH ) {( MH )}^{T} , \qquad ( 1 )$$

where H is a centering matrix whose purpose is to subtract the mean model from each of the columns of matrix M. This centering matrix is defined by

$$MH = M - {μ1}^{T} = M ( I - \frac{1}{N} {11}^{T} ) .$$

Performing an eigenvalue decomposition of Σ as

Σ=U [symbol] ²U^{T}. (2)

where U^{T}U=1 and [symbol] is a diagonal matrix of dimension N×N, the principal directions are given by the columns of U=[u₁, . . . , u_{N}] and the principal values are variances given by the diagonal elements of [symbol] , denoted {λ₁, . . . , λ_{N}}. The λᵢ are non-negative, and it is assumed here that they have been sorted in order of descending value. Note that when the number of model parameters is larger than N, the eigenvalues {λᵢ:i>N} are exactly zero, so we drop these eigenvalues from [symbol] and their corresponding columns from U. Thus, even for large models, [symbol] is N×N and U has only N columns.

The first step in PCA is to define a new coordinate system, the feature space, that is aligned with these principal axes (simply a rotation) and scaled by the principal values. The transformation yielding this new coordinate system is found by projecting the model vectors onto the principal axes and then scaling:

F= [symbol] ⁻¹U^{T}MH. (3)

The transformed samples are the columns of F, and are denoted by F=[f₁, . . . , f_{N}].

The covariance matrix of these transformed samples, defined by

$$\frac{1}{N} {FF}^{T} ,$$

equals the identity matrix. This can be demonstrated by performing the singular-value decomposition

$$\frac{1}{\sqrt{N}} MH = {UΛV}^{T} , \qquad ( 4 )$$

where U has the same meaning as above and [symbol] ^{T} [symbol] =1, which is consistent with (1) and (2), substituting it into (3) and writing the covariance of F as

$$\frac{1}{N} {FF}^{T} .$$

This means that, although the models are correlated in the original model space, they are uncorrelated with unit variance in the feature space.

In the feature space, model reduction is accomplished by eliminating coordinates with insignificant variance. This is achieved by eliminating columns and rows from [symbol] and columns from U that are associated with small principal values. These truncated matrices are denoted by [symbol] and Û. The transformation from model space into the reduced feature space is given by

\hat{F}= [symbol] ⁻¹Û^{T}MH. (5)

While (5) shows how to map the points describing the prior model uncertainty into their corresponding points in the latent-variable space, this linear transformation can be applied to map any point in the model space into the latent-variable space, namely,

\hat{f}= [symbol] ⁻¹Û^{T}(m−μ), (6)

Where μ is the mean model vector. The inverse mapping is given by=

\hat{m}=Û [symbol] \hat{f}+μ (7)

Note that this inverse mapping transforms the latent vector back into a subspace of the model space that is spanned by the columns of Û.

The unreduced inverse mapping can also be expressed in terms of M by writing (4) as

$$UΛ = \frac{1}{\sqrt{N}} MHV$$

and substituting this into the unreduced form of (7) to get

$$m = \frac{1}{\sqrt{N}} MHVf + μ . \qquad ( 8 )$$

By using a reduced feature space, as in

$$\hat{m} = \frac{1}{\sqrt{N}} MH \hat{V} \hat{f} + μ , \qquad ( 9 )$$

\hat{m} clearly lies in a subspace of the column space of M.

The above formulation of PCA, in terms of the eigen decomposition of Σ, is inefficient when the number of elements in the model vector, D, greatly exceeds N resulting in a D×D matrix Σ that is typically too large to store in a desktop computer. A more efficient approach is found by recognizing that [symbol] and U can also be found by solving for the eigenvalues and eigenvectors of a smaller inner-product matrix, called the kernel matrix, defined by

$$B = \frac{1}{N} {( MH )}^{T} ( MH ) . \qquad ( 10 )$$

This can be seen by performing the singular-value decomposition of

$$\frac{1}{\sqrt{N}} MH ,$$

given in (4), into (1) to get B= [symbol] ²V^{T}. This provides [symbol] . U can then be obtained from V from (4) as

$$U = \frac{1}{\sqrt{N}} ( MH ) {VΛ}^{- 1} . \qquad ( 11 )$$

### Multidimensional Scaling

An alternative expression of PCA is given by classical multidimensional scaling (MDS) analysis. Here, instead of operating directly on the model matrix M, a dissimilarity matrix, Δ, is constructed whose elements are proportional to the squared Euclidean distances between the models, namely,

$${Δ}_{i , j} = - \frac{1}{2} {‖ {m}_{i} - {m}_{j} ‖}^{2} . \qquad ( 12 )$$

Given Δ, the goal is to find a coordinate system whose points, fᵢ, satisfy the minimization problem

$${min}_{{f}_{1} , … , {f}_{N}} {\sum }_{i < j} {( ‖ {m}_{i} - {m}_{j} ‖ - {Δ}_{i , j} )}^{2} . \qquad ( 13 )$$

The kernel matrix, B, that is central to PCA can be expressed in terms of Δ as

$$B = \frac{1}{N} H Δ H . \qquad ( 14 )$$

Since B in (1) is identical to that defined in (1) for PCA, the eigenvalue and eigenvector matrices, [symbol] and [symbol] , are identical for PCA and classical MDS. Thus, we can use (5) to map between M and F. Since M is not available in this approach (we are only given Δ), we substitute HM=\sqrt{N}U [symbol] ^{T} into the unsealed version of (5), i.e., -\hat{F}=U^{T}HM, to get

\hat{F}=\sqrt{N} [symbol] ^{T}. (15)

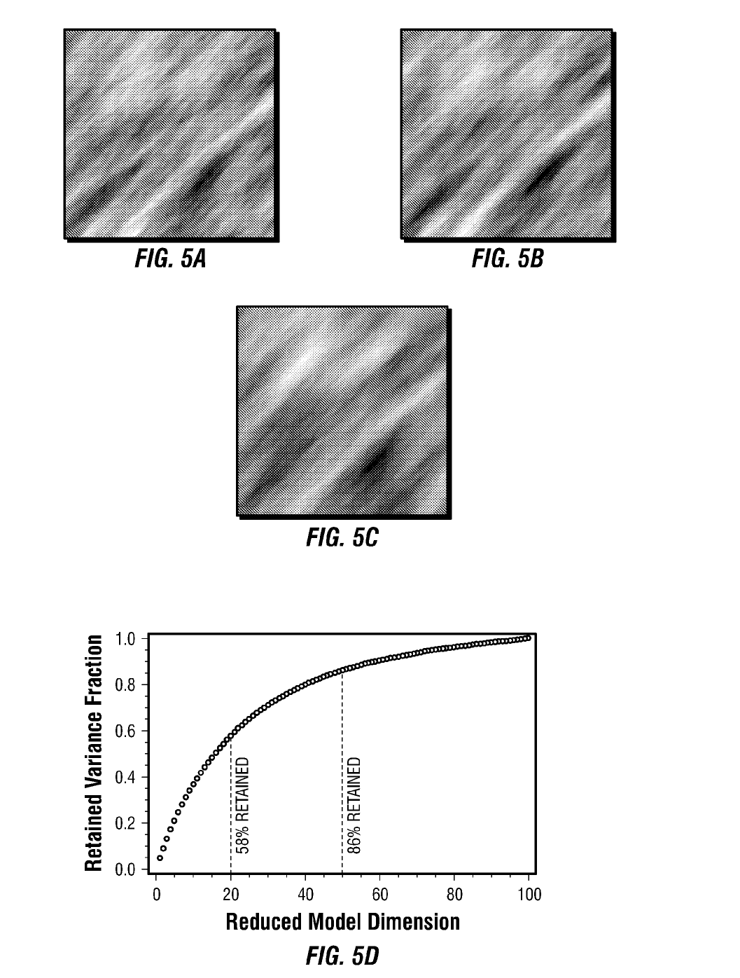

The impact of dimension reduction on a 10⁴-dimensional example is illustrated in FIG. 5. Here, the uncertainty is represented by 100 samples from a multinormal distribution with a spherical variogram function whose major axis is oriented at 45 degrees, with the major-axis range being five times larger than the minor-axis range. One of these samples is illustrated in FIG. 5(a). FIG. 5(b) shows the results of projecting this model into a 50-dimensional latent space, using (6), and then transforming back into the original model space, using (9). Note that the trends and features of the original model are captured in this reduced-parameter model. This result may be surprising, since, in a model optimization setting, the original 10⁴-parameter optimization problem can be optimized, with reasonable model fidelity, using only 50 parameters. The impact of further reduction of the model to 20 parameters is shown in FIG. 5(c). Even here, the trends are still preserved, although many of the model features have been visibly smoothed. The retained variance versus reduced-model size is illustrated in FIG. 5(d). The retained variance fraction is defined as the ratio of summed variances of the retained parameters over the sum of all variances. This shows that the total variance has been reduced by only 14 percent in the 50-parameter representation, and by 42 percent in the 20-parameter case. Fewer variables result in greater smoothing, with the degree of variance retained versus the number of latent variables is indicated in (d). The variance-reduction plot also gives an indication of whether the number of models used to represent uncertainty is adequate, by examining whether the right-hand side of the curve is suitably close to having a zero slope.

### PCA Model Reduction Considerations

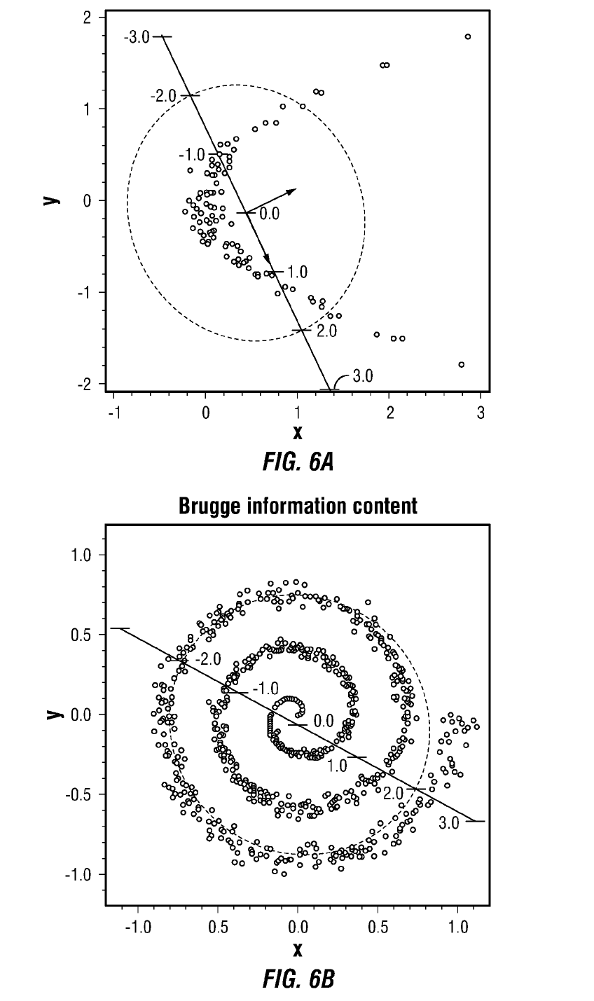

The main shortcoming of PCA model reduction is that it assumes that the model uncertainty is well-approximated by a multinormal distribution. For example, consider a two-dimensional model with the distribution function shown in FIG. 6(a). The 100 samples were drawn from a unit multinormal distribution, N(0,1), and quadratically transformed by

$$\{ {x}^{′} , {y}^{′} \} = \{ ( \frac{x}{10} + \frac{2 {y}^{2}}{5} ) , \frac{2}{3} y \}$$

to yield the parabolic shape of the distribution. PCA analysis of the 100 samples yields the two principal axes, indicated by arrows, and the two-sigma contour (with a Mahalanobis distance of two.

The Mahalanobis distance is a covariance-weighted distance from the mean, defined by d(x)=\sqrt{(x−μ)^{T}Σ⁻¹(x−μ)}.), indicated by a dashed ellipse, illustrating the sample covariance. The gray line indicates the principal axis onto which the samples would be projected in reducing the two dimensions down to one, and the gray numbers indicate the 1D coordinate system in that reduced space. Since the distribution strongly deviates from a multinormal distribution, the principal axes determined by the PCA analysis bear little relation to the true distribution. Indeed, the PCA mean lies outside of the likely region of the distribution, and samples drawn from the multinormal distribution resulting from the PCA analysis would mostly lie outside of the true distribution. Almost all of the models deemed valid in the reduced coordinates (the models between −2 and +2 in the reduced coordinate system) are indeed invalid in the original model space. In the context of our history-matching application, most of the models deemed acceptable by the PCA analysis would violate the prior distribution.

In a second example, shown in FIG. 6(b), 1000 samples are drawn in polar coordinated from a spiral-shaped distribution defined by r θ/(Σπ) , where r˜N(1, 0.05) and θ˜U(0, 6π). PCA analysis of these samples yields the principal axes, indicated by arrows, and the two-sigma likely region, indicated by a dashed ellipse. Once again, the majority of models deemed acceptable by the PCA analysis would violate the prior distribution. The likely models suggested by the 1D reduced space deduced from PCA, indicated by the gray line in the coordinate range from −2 to +2, also contains a large proportion of invalid models.

These two examples motivate the development of nonlinear form of PCA that allows the principal axes to nonlinearly conform to the trends in the prior distribution. In the following section, we examine the Isomap algorithm as a practical implementation of nonlinear PCA for use in history matching, and consider extensions that improve its robustness.

### Kernel PCA

In classical multidimensional scaling (MDS), instead of applying PCA to a set of N samples, the analysis is performed on an N×N matrix of Euclidean distances between the samples. This approach is equivalent to PCA in that it yields principal values and directions, and provides a two-way linear mapping between model space and the reduced space. Since a distance matrix is independent of a coordinate system, the reconstructed model-space points are faithfully reproduced modulo translation, rotation and reflection. This distance-preserving map between metric spaces is called an isometry, and geometric figures that can be related by an isometry are called congruent.

The Isomap algorithm uses a generalization of MDS in which the distance table measures geodesic distances along the model manifold defined by the model points themselves, instead of Euclidean distances. For example, for the distribution in FIG. 6(a), one could imagine applying a quadratic mapping of the space into a new space in which the distribution is multinormal (mapping the parabola into an ellipse), and then performing PCA on the mapped samples. Generalized MDS achieves this by measuring distances, not along the Euclidean axes, but rather along geodesics that conform to this mapping. Since these geodesics are not known precisely, Isomap approximates them using graph theory. Starting with a graph of the samples in which the samples are nodes, each sample is connected to all neighboring samples (within a radius R or the K nearest neighbors) by edges whose weights are the Euclidean distances between the neighboring samples. The Dijkstra algorithm can then be applied to determine the shortest-path (geodesic) distances between nodes on the graph. The resulting distance table can then be used in the classical MDS algorithm to map between the model space and the feature space.

The IsoMap algorithm will only be successful when the neighborhood is chosen small enough to preserve the locality of the Isomap mapping, i.e., the neighborhood must be chosen sufficiently small such that distant points on the manifold are not joined as neighbors. For example, in FIG. 6(b), the neighborhood must be chosen such that a point on one spiral will not be neighbored with points on a different branch of the spiral. Such a neighborhood can always be defined as long as the sampling density is sufficiently high. In numerical examples, we show that reasonable choices for these neighborhood parameters can be quantitatively selected for our 2D examples by using graph diameter as an indicator of when K becomes too large, but this indicator was not useful in our 100×100 image examples, where a qualitative selecting criterion is more effective.

One caveat with using MDS is that the kernel matrix, B, defined above, which links the model space with the feature space through its eigen decomposition, sometimes possesses negative eigenvalues. When this happens, the feature-space dimensions with negative eigenvalues have no Euclidean representation. Furthermore, with negative eigenvalues, B does not satisfy Mercer's Theorem (Mercer's theorem provides the conditions under which MDS yields a valid kernel matrix, and thus defines a valid feature space,) and, thus, is not a kernel matrix. Note that with PCA, the eigenvalues are guaranteed to be non-negative. This problem has long been known for MDS, and we use the accepted solution of adding the smallest possible positive constant to all of the non-diagonal elements of the distance matrix in order to make the eigenvalues of B non-negative. B is then a kernel matrix satisfying Mercer's Theorem, enabling fast algorithms for mapping subsequent model points into feature space using the generalization property.

This correction to B ensures its positive semi-definiteness, thus guaranteeing an Euclidean feature-space representation for all choices of K. In the limit of K→N, the geodesic distances converge to Euclidean distances, making the kernel Isomap results identical to those of PCA. The neighborhood parameter, K, can thus be thought of as a nonlinearity tuning parameter that, in one extreme (K=N), devolves the results to those of traditional linear PCA, and in the other extreme of small K, produces highly nonlinear results that are overly sensitive to the noise in the model points. We call this algorithm kernel PCA (kPCA) because it can be thought of as encompassing all of the benefits of PCA, while allowing nonlinearity to be accommodated through the parameter K.

kPCA provides a one-way mapping between points in the model space and points in the latent space. In order to be useful for history matching, it is necessary to map points suggested by the optimizer in the latent coordinate system back into the original model space. This is called the pre-image problem. Finding a robust inverse mapping has plagued many other applications of kernel methods. The formulation of the Isomap algorithm in terms of preserving isometries between neighborhoods in the model space and neighborhoods in the latent space suggests a solution to the pre-image problem. Given that the above neighborhood condition is met, an approximate inverse mapping can be formulated by preserving these isometries in the inverse mapping. In short, when a point in latent space is to be mapped into model space, its K nearest neighbors in latent space are identified (by smallest Euclidean distance). These neighbors are associated with their K counterparts in model space. An analytical mapping is found between these two spaces that best preserves the isomorphism between these neighborhoods of points. This is a linear mapping of the form

\dot{m}=M_{K}c(\hat{f}), (16)

where M_{K} are the columns of M corresponding to the model-space K neighborhood, c is a vector of interpolating coefficients (a function of \hat{f}) that sums to one. Since the interpolating coefficients sum to one, any hard data used to condition M will be honored in m. This algorithm is fast, easy to implement, and worked well for all of the examples herein.

### History Matching

In the previous sections, the concept of a geostatistical prior has been introduced. The prior defines a region of interest in the model space. Linear PCA has been used for model reduction, thus defining a mapping to and from a low-dimensional feature space in which it is easy to generate new points. These points give rise to models in, or near, the region of interest and are consistent with the geological constraints.

Automated optimization algorithms may be used to search the feature space for configurations of parameters that map to models matching the history. Such an optimization has two goals, both of which must be encapsulated in the objective function: providing a good fit to the production history and providing a probable model with respect to the prior distribution. We use a Bayesian methodology to meet these goals, with the data fit controlled by a multi-normal likelihood distribution and the prior fit controlled by a multi-normal prior distribution. The objective function is then proportional to the log of the posterior distribution. The resulting optimization solution is the maximum a posteriori (MAP) solution.

g(y)∝(f_{g}−fₒ)^{T}Σ⁻¹(f_{g}−fₒ)+y^{T}y. (17)

Here, g(y) denotes the objective function, f_{g}=f(y) are the simulated results (f(·) denoting the simulator function), f₀ denotes the observed data and Σ is the matrix of measurement errors. The role of the optimization algorithm is to find the value of the vector y that minimizes g(y). In the Brugge study below, the covariance matrix E was chosen to be diagonal, with the values along the diagonal chosen to normalize the measurements to have the same range of values.

It has been mentioned that the feature space is continuous, which means that it is possible to use gradient-based optimization methods, even if the prior models are non-continuous. We utilized a derivative-free optimization algorithm from the Aurum Optimization Library (abbreviated to AOL). The coefficients of the feature space vector are the control parameters that are altered by the algorithm. These alterations affect the rock properties in the simulation model. In this example, porosity, permeability (in x-, y- and z-directions) and net-to-gross ratios are used.

At each iteration, the optimizer updates its estimate of the location of the optimum in the feature space. These coordinates are then mapped into the model space, where the resulting simulation model can be run. Fluids and pressures are equilibrated by the simulator at the beginning of each run, and the model is then simulated using the historical injection and production rates. These steps are repeated until the objective function has been minimized. The optimization is a bottleneck of this workflow as the multiple simulation runs have not been run in concurrently. Other optimization algorithms may be more efficient in making use of concurrency to speed up this step in the workflow.

### PCA Experimental Results

### The Brugge Model

The Brugge model was used to demonstrate how a problem with 104 prior models and more than 300,000 variables can be reduced to only 40 parameters without significant loss of information (See, generally, E. Peters, et al “Results of the Brugge Benchmark Study for Flooding Optimization and History Matching,” SPE Reservoir Evaluation & Engineering, June 2010, pages 391-405). Here, the observed data consists of BHP for the 30 wells as well as water and oil rates for the 20 producing wells, observed on a (roughly) monthly basis for 10 years (M=8890).

The Brugge model was used as the test case as it provides an excellent benchmark for both history matching and forecast optimization. It is reasonably geologically complex, possesses operationally realistic scenarios and the developers of the model, using custom code, established the global optimum values upon which we may measure the quality of our HM model. Not only are we able to match history against the data but, more importantly, we can determine how well a forecast from the history-matched model performs when run against the ‘truth’ model. Participants submit their optimized operational control settings to TNO, who in turn, passed them through the actual ‘truth’ model and returned the results. In this section, history matching using the Brugge model is discussed. This involves an automated search of the feature space. The resulting history-matched model is used as the basis for an optimized strategy to maximize the NPV of a 20-year forecast, which is then validated against the ‘truth’ model.

First, linear PCA is used to create a model representation in a reduced-dimensional parameter space, and the properties of this reduced representation are discussed. The re-parametrized model is then history matched using an optimization algorithm. Then, the history matched (HM) model is used as the basis for a 20-year forecast optimization, the results of which are compared to TNO results. This work was conducted using Petrel™ 2010.1, the PCA algorithm was prototyped using Ocean™ and MATLAB.ECLIPSE™ 2009.2 was used for reservoir simulation and the Aurum Optimization Library (AOL) was used as the optimization engine.

In the Brugge example, the model space has dimension N=300240, which comprises the number of porosity, permeability and net-to-gross ratio values in the model. There are L=104 prior realizations that have been provided by TNO (the challenge hosts). These realizations were generated by methods that draw from Gaussian and non-Gaussian distributions. The covariance matrix has 104 non-zero eigenvalues (this is not a coincidence as the number of non-zero eigenvalues equals to the number of linearly independent points) and we choose D=40 parameters to represent the feature space. This number represents a trade-off between reducing the number of parameters and keeping the model reduction error reasonably small.

The error introduced by the model reduction (also referred to as the ‘loss of information’) can be quantified by the ratio of retained eigenvalues over all eigenvalues, namely:

$$q = \frac{{\sum }_{i = 1}^{D} {λ}_{i}}{{\sum }_{i = 1}^{L} {λ}_{i}} . \qquad ( 18 )$$

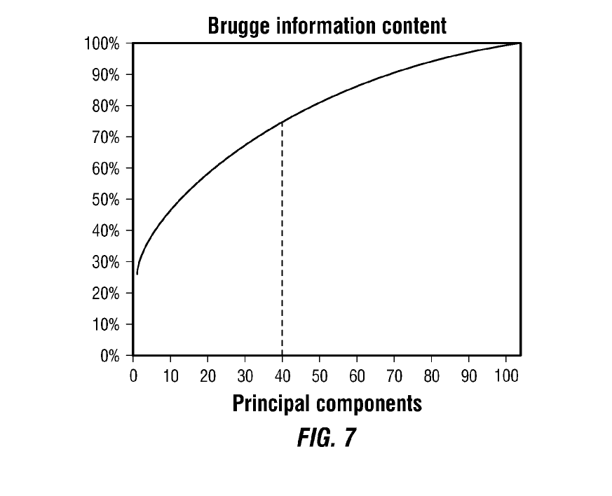

Note that the error introduced by bias in estimating p and C from a limited number of samples, as well as the error arising from non-Gaussian prior samples, is not captured by this estimate. FIG. 7 shows the information content calculated for the Brugge model, and demonstrates that it is possible to represent the Brugge model, with its 300240 parameters, by only 40 parameters in the feature space, while retaining 75 percent of the information content of the prior models. It is worth noting that this analysis is highly problem-specific and that other reservoir models may require more feature space parameters to retain a reasonable level of information content. FIG. 7 includes the information content of the Brugge model as a function of the number of principal components. The vertical line indicates a model reduction to 40 parameters, which corresponds to a retained information content of 75 percent.

It is through the combination of history matching and subsequent forecast optimization that we may authoritatively evaluate the validity, suitability, and quality of the final history-matched model. The model consisted of a truth case, details of which have been kept secret, and a set of data that is available to anyone interested in competing. Participants were asked to build a history-matched simulation model based on 10 years of production data obtained from the undisclosed ‘truth’ model. Geological uncertainty was represented by a set of 104 equi-probable models that did not include the truth model. Subsequently, an optimized production strategy for a 20-year forecast was sought, the results of which were then compared against the optimized truth case. While the truth case remains unknown to us, the model owners ran our PCA HM model against the truth case for comparison and validation purposes.

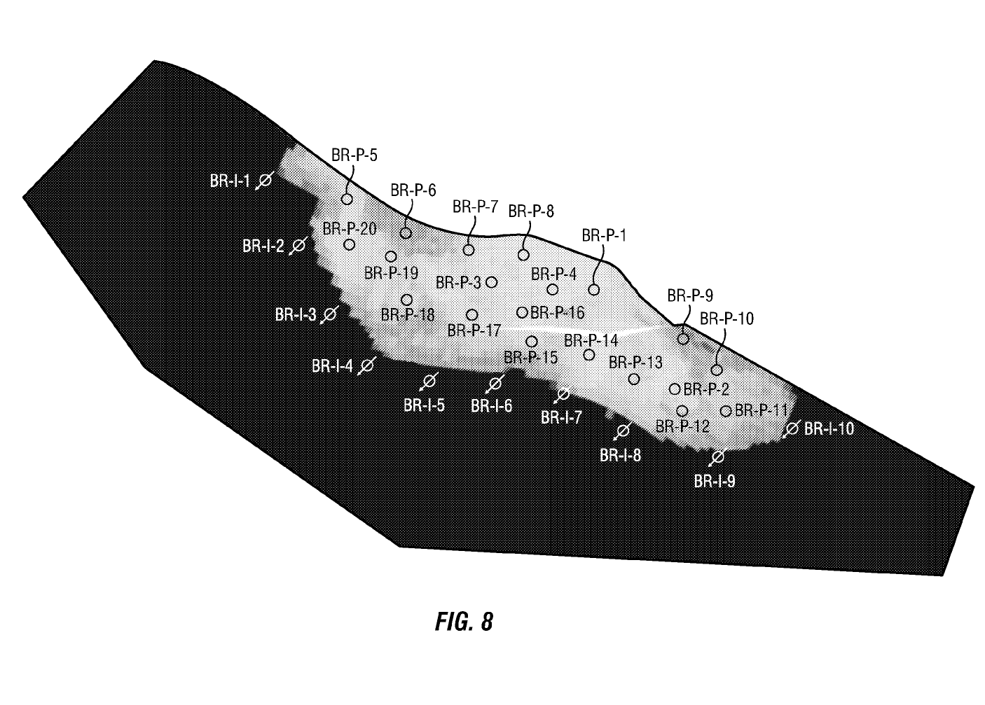

FIG. 8 provides an aerial view of the Brugge field looking down on the top Schelde (layer 1). The grid shows water saturation for one typical prior realization (of which there exist 104). Also marked are well locations and their names (producers have the suffix ‘BR-P-’ and injectors have suffix ‘BR-I-’).

The Brugge model is a dome-shaped reservoir of 30×10 km with sealing faults on all sides except for an aquifer on the Southern edges. The upscaled simulation model has 60048 grid cells (139×48×9) with 30 wells (20 producers and 10 injectors). The simulation model and the well locations are shown in FIG. 8, with model details outlined in Table 1.

TABLE 1
Basic properties of the Brugge simulation model.

| Property | Description |
|---|---|
| Grid | 139 × 48 × 9 (total of 60,048 active cells) |
| Producers | 20 wells |
| | History period (0-10 LRAT 2000 bbl/d, BHP 725 psi |
| | years): |
| | Forecast period (10-30 LRAT 3000 bbl/d, BHP 725 psi |
| | years): |
| Injectors | 10 wells |
| | For all periods (0-30 WINJ 4000 bbl/d, BHP 2611 psi |
| | years): |
| Initialization | Equilibrium pressure: 2,466 psi at 5,577 ft (TVD) |
| | Free water level: 5,505 ft |
| Rock | Pore compressibility: 3.5 × 10⁻⁶ 1/psi |
| Saturation | 7 saturation regions delineated as a function of |
| | porosity, φ (capillary pressures and Corey permeability |
| | models) |
| Fluids | Oil and water only |
| Density | Water: 62.6 lbs/ft³; Oil: 56.0 lbs/ft³ |
| Compressibility | Water: 3.00 × 10⁻⁶ 1/psi; Oil: 9.26 × 10⁻⁶ 1/psi |
| Viscosity | Water: 0.320 cP; Oil: 1.294 cP |

LRAT: Total Liquid Rate;
BHP: Bottom Hole Pressure;
WINJ: Water Injection Rate

### Brugge History Matching

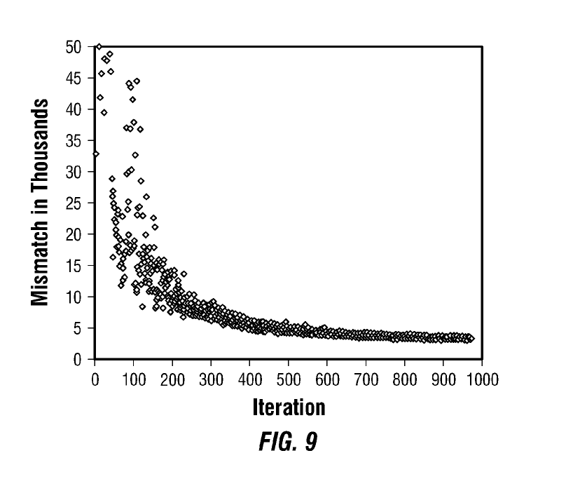

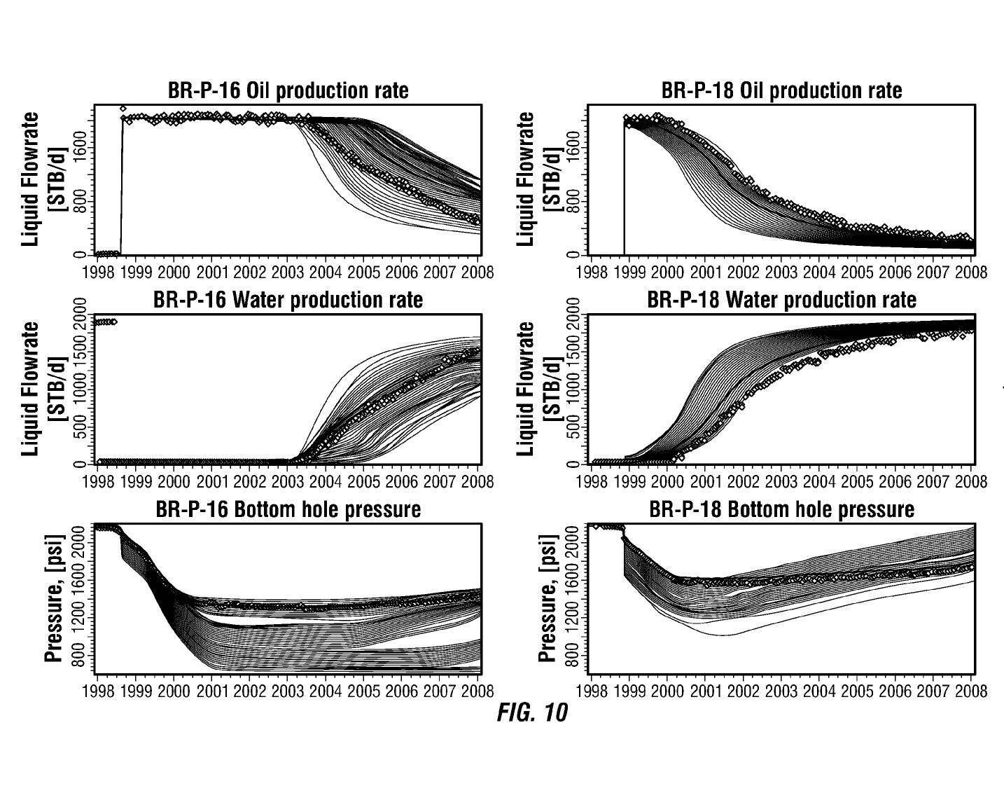

While the structure and fluid properties are given, the make-up of the rock and initial saturations are unknown. 104 realizations of the 3D properties were generated using geostatistical algorithms and provided the following properties: porosity, permeability in x-, y- and z-directions, net-to-gross ratio, initial water saturation and facies. These realizations, together with the production history for the 30 wells (bottom hole pressure, oil and water production rates, and water injection rates), form the input to the history-matching task. In this example, the process converged after 957 iterations, with the progress of the optimization shown in FIG. 9. FIG. 9 plots the history-matching optimization convergence versus iteration number. Each iteration requires one simulation. The mismatch value is computed using Eq.(17), which provides a relative measure of the quality of each trial.

The history-matching results for selected wells are shown in FIG. 10, that illustrates summary data for wells BR-P-16 (best well-match; left) and BR-P-18 (worst well-match; right). The light gray curves are the data generated from the prior models, the smooth, thin line curves indicate the history-matched results, and the observed data are shown as points. These results indicate a high quality of history match. Note in the lower right-hand panel of FIG. 10 that a good fit to pressure is found even though none of the prior models used to create the latent space possesses even the correct trends.

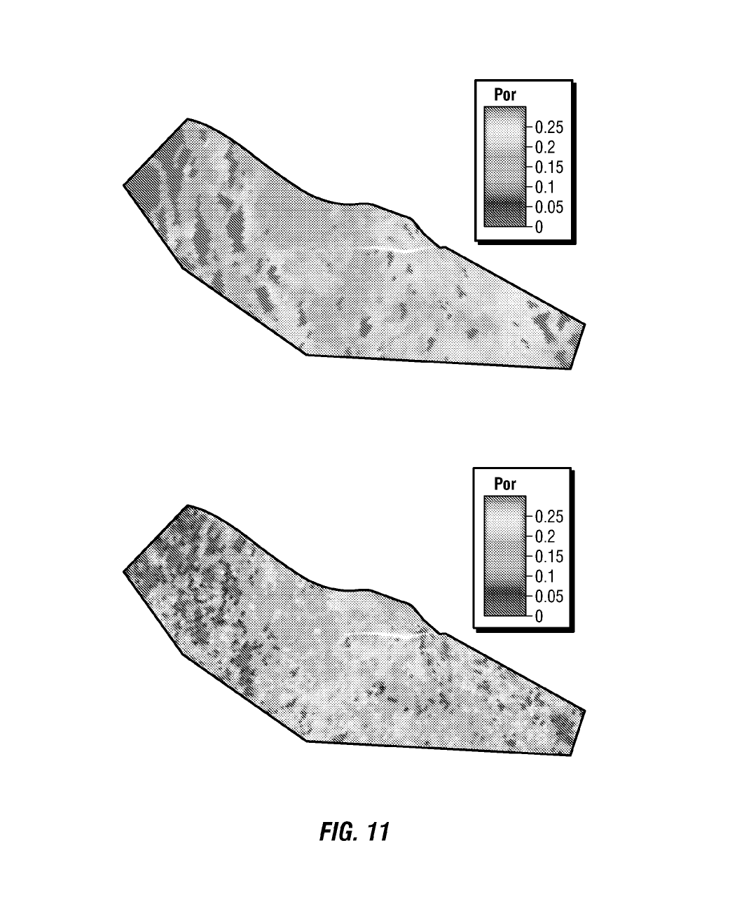

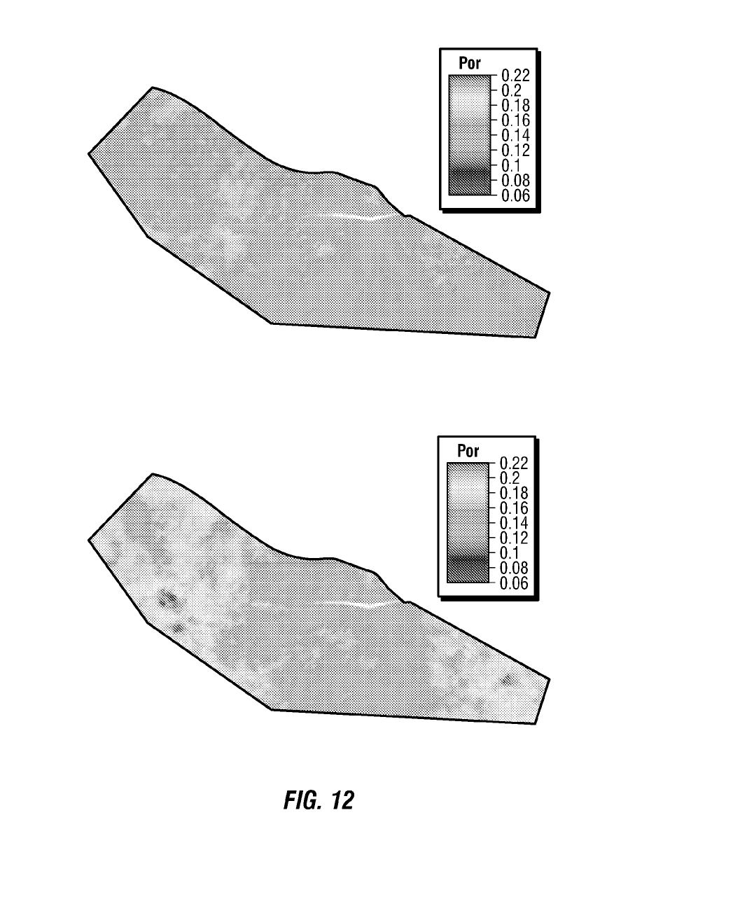

We now examine differences in the porosity grid between a typical prior model and the history-matched model for two model layers. FIG. 11 shows an aerial view of the Schelde formation (Layer 1). Shown is the porosity grid for a typical prior model (top) and the history-matched model (bottom). The prior model shows sharp contrasts in porosity as a result of channels in the geological model. The history-matched model (bottom) does not reproduce these sharp features, but results is a model with smoothed transitions and some noise (heterogeneity on a smaller length-scale than is present in the geological model). This is because PCA uses a first-order approximation which cannot represent step-changes correctly. However, the general direction of the channels has been preserved and the distribution of porosity within the features is modeled correctly. This demonstrates the robustness of the PCA approach in handling models that are not well described by a Gaussian prior. In this case, the PCA approximation yields a least-squares approximation the captures both the first and second moments of the non-Gaussian prior. The geological prior for the Maas formation, shown in FIG. 12, is relatively simple, as its facies model is almost entirely homogeneous. As a result, this prior is well suited for PCA and the resulting history-matched model clearly resembles the geological prior (FIG. 12, bottom). Note that the color-scaling differs from FIG. 11 to allow for clearer visual inspection. The history-matched model (bottom) shows geological features at the same length scale and parameter range as the prior model (top). Both models satisfy similar geostatistical constraints.

It is evident from FIG. 10 that the PCA algorithm performs robustly, even if the input data are (partly) non-Gaussian. Furthermore, the geological formations form statistically independent subsets of parameters, so the geological realism is preserved in those layers that have Gaussian geostatistics. This shows that this algorithm may be applied to models with non-Gaussian priors, but the geological constraints will be smoothly approximated within a Gaussian assumption.

### Production Estimation and Validation

Conducting a history match does not, in itself, provide any real indication about the predictive quality of the model, it only minimizes the difference between the observed and simulated data. In the case of Brugge, however, it is possible to appraise and validate the HM model against a ‘truth’ case. This is achieved by creating a production strategy for the forecast period, which requires further optimization. Well rates (production and injection) were used as control parameters, resulting in an optimal strategy with respect to the HM model, but in full knowledge that it may remain suboptimal with respect to the actual ‘truth’ case. The objective function for the Brugge 20-year forecast is net-present value (NPV), the parameters of which are shown in Table 2.

### Test #1: Non-Optimized Comparison

The first test compares the PCA HM model non-optimized 20-year forecast NPV (using the operational settings shown in Table 2) against the published equivalent ‘truth’ TNO forecast NPV:

| PCGA HM model forecast NPV | US$3.95 × 10⁹ |
|---|---|
| TNO's ‘truth’ forecast NPV | US$4.19 × 10⁹ |
| Difference | −5.73% |

It should be noted that no equivalent values for this non-optimized test from other participants were published.

TABLE 2
Economic parameters and well constraints for forecast period (these are
also used as the non-optimized ‘default’ operating strategy).

| Reservoir | |
|---|---|
| Simulator | ECLIPSE |
| History-Match | Starts: 1 Jan. 1998 (day 1) |
| Period | Ends: 31 Dec. 2007 (day 3,651, 10 years) |
| Forecast | Starts: 1 Jan. 2008 (day 3,652, 10 years) |
| Period | Ends: 1 Jan. 2028 (day 10,957, 30 years) |
| NPV | Oil Price = $80/bbl (produced oil, FOPT) |
| Parameters | Water Processing Cost = $5/bbl (produced water, |
| | FWPT) |
| | Injection Cost = $5/bbl (injected water, FWIT) |
| | Discount Rate = 10% per annum |
| | (discounting begins 1 Jan. 2008) |
| Constraints | Max. production rate (per well): 3000 bbl/day (liquid) |
| (default fore- | Min. producer BHP: 725 psi |
| cast operating | Max. injection rate (per well): 4000 bbl/day (water) |
| strategy) | Max. injection BHP: 2,611 psi |

FOPT: Field Oil Production Total (cumulative oil);
FWPT: Field Water Production Total (cumulative produced water);
FWIT: Field Water Injection Total (cumulative water injected)

### Test #2: Optimized Comparison

The second test involved optimization of the HM model over a 20-year forecast period. The result achieved with linear PCA has the lowest estimation error and highest achieved NPV compared with all other published workshop participant results.

The realized NPV of US$4.49×10⁹ is the result of a combination of both successful history matching and proficient forecast optimization. Of significance is the small estimation error of 1.81 percent—which indicates that the PCA HM model has a closer resemblance to the unknown ‘truth’ case than any of the other participants. As the true global optimum NPV of Brugge is $4.66×10⁹, this indicates that the optimum strategy is still suboptimal, by 5.66 percent, implying that there is still some upside potential to be obtained from PCA and/or forecast optimization. It should be noted that the Brugge challenge requires history matching and production optimization with a lack of information.

kPCA Experimental Results

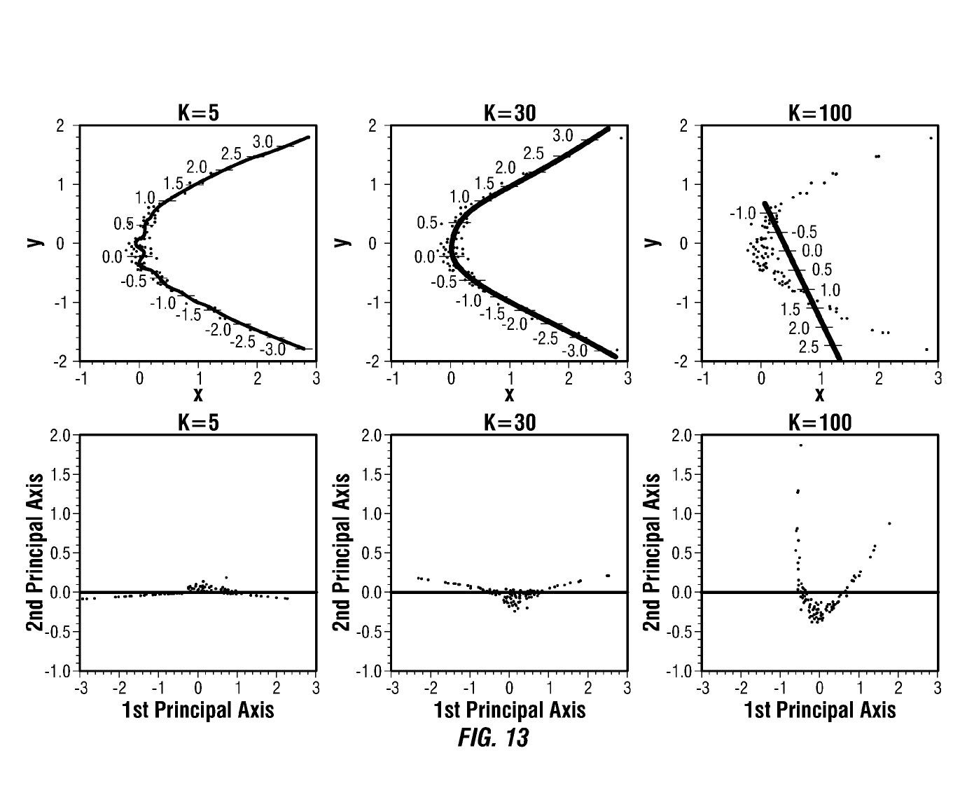

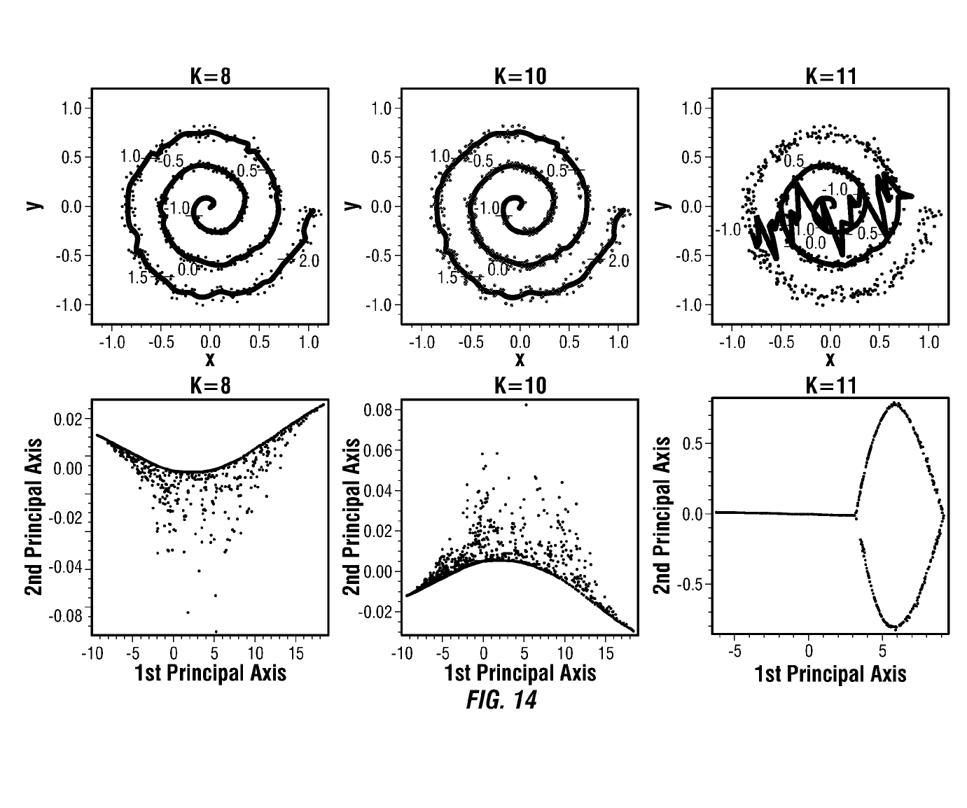

FIG. 13 presents three Isomap mappings, for three values of K, of the samples from FIG. 6(a) into a 2D reduced space, alongside a mapping of the 1D reduced space back into the original model space. K indicates the number of neighboring samples used to construct the nearest-neighbor graph. Consider the K=5 plot in the first row of FIG. 13. FIG. 13 has plots that show the kPCA mappings of the FIG. 6(a) samples into a 1D latent space, as they appear when projected back into the original 2D model space. The dots are the original model points, the gray curves (with annotated coordinate numbers) are the 1D latent coordinates as they appear in the model space. K indicates the number of neighboring samples used to construct the nearest-neighbor graph. K=100 is identical to the PCA solution. (Bottom Row) These are the model points as they are mapped into a 2D feature space. The K=100 solution points are congruent with the original model points. FIG. 14 provides kPCA mappings of the FIG. 6(b) samples into a 1D latent space, as they appear when projected back into the original 2D model space.

The 1D latent coordinate system found by kPCA is clearly better than the PCA results shown in FIG. 6(a). The coordinates printed alongside the gray curve indicate the latent coordinate system, and correspond to a 1D unit normal distribution in the latent variable. The 1D manifold clearly follows the quadratic shape of the point set, but over-fitting is apparent as the curve fits the random deviations into the second dimension of the latent manifold. This is largely overcome in the K=30 results, where the neighborhood is large enough to provide a better measure of distances along the manifold. The K=100 solution is provided to demonstrate that this case yields the PCA solution, as compared to FIG. 6(a).

The second row of plots in FIG. 13 show the mapping of the model points into a 2D feature space. The K=5 and K=30 indicate little variation in the second coordinate, demonstrating that little variance is lost when the second feature-space coordinate is dropped. The K=100 solution presents feature-space points that are congruent with, but not identical to, the original model points, an expected result for MDS. Dropping the second coordinate in the K=100 results would clearly result in significant loss of variance, which explains the poor fit illustrated in the first row.

We now consider the dimension reduction of the samples in FIG. 6(b). The kPCA mappings of these samples for three values of K are shown in FIG. 14. For these samples, k_{crit}=8. K=10 provides a smooth recovery of the spiral curve, while the nearest-neighbor graph for K=11 is clearly incorrect since it joins samples from different branches of the spiral. K=10 is the optimal choice for the neighborhood size.

### Choosing K

The proper choice of the neighborhood size, K, is critical for achieving a good mapping into feature space. There are three regimes to consider in the choice of K: sub-critical, local neighborhood, and short circuit. In the sub-critical regime, K is chosen so small that the graph becomes disconnected. k_{crit} is the smallest value of K for which the graph is connected. To demonstrate connectedness, consider a 1D domain with four points at {−2, −1, 1, 2}. With K=1, the left- and rightmost pairs of points will be joined, but there is no connection between the center pair of points. Thus there is no graph path that can connect the left point with the right point. K=2 is the minimum value that will produce a connected graph, yielding=2. In the case of the model points in FIGS. 6(a) and 6(b), K_{crit}=5 and K_{crit}=8, respectively.

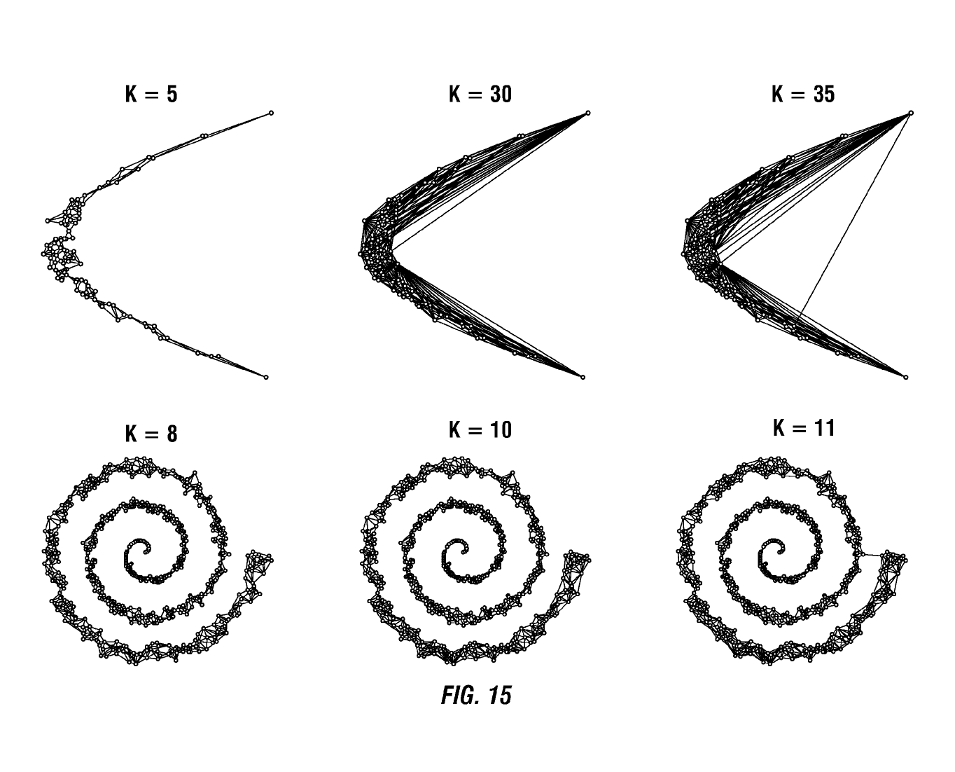

The second regime is where the graph is connected and paths between points remain close to the manifold. In this case, low values of K tend to result in overfitting, as is seen in the top row of FIG. 13 for K=5. By including more points in the neighborhood, more paths are allowed between points on the manifold, resulting is better approximations of distance along manifold geodesics. Thus, larger values of K1 are preferred within this regime. Plots of the graphs for K=5 and K=30, given in the top row of FIG. 15, illustrate that increasing K within this regime increases the possible geodesic paths, thus providing more accurate distance estimates along the geodesics. Graph plots for the model points of FIG. 6(b) are provided in the bottom row of FIG. 15. In this case, it is clear that the graph first short circuits at K=11, making K=10 the optimal choice.

As K continues to increase, there comes a point at which graph edges begin to connect points that are not near neighbors on the manifold. The value of K at which this occurs is often not abrupt, but this marks the transition into the short-circuit regime. The graph plots in the top row of FIG. 15 for K=30 and K=35 illustrate this transition. Mild short-circuiting is apparent for K=30, but the impact is dramatic for K=35. This transition is abrupt for the spiral data, as seen by comparing the K=10 and K=11 results in the bottom row of FIG. 15.

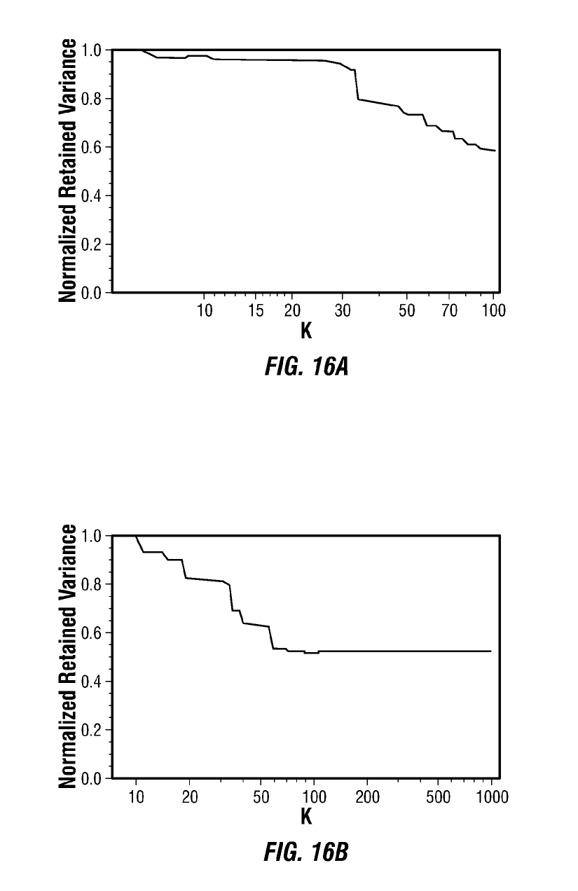

In order to find a robust indicator for guiding the choice of K, several measures were considered, including retained variance and several graph metrics. Retained variance is an interesting possibility for two reasons: its connection with PCA in the choice of the number of latent variables, and the observation that in the second rows of FIGS. 13 and 14, the retained variance decreases with increasing K. Retained variance in these 2D examples is defined as A₁²/(A₁²=Δ/A₂²), and is plotted versus K for the parabolic and spiral samples in FIGS. 16(a) and 16(b), respectively. The retained variance for both sample sets presents a decline with increasing K, with significant step decreases where the graph first short circuits. For the parabolic sample set, the largest step decline occurs at K=33, at the point where its graph first short circuits. Conversely, for the spiral sample set, the largest step decline occurs at K=33, notably far above the optimal K=10 value. Thus, although regained variance fraction is sensitive to the short circuiting of the graph, it does not present a conclusive indicator of where short circuiting first occurs.

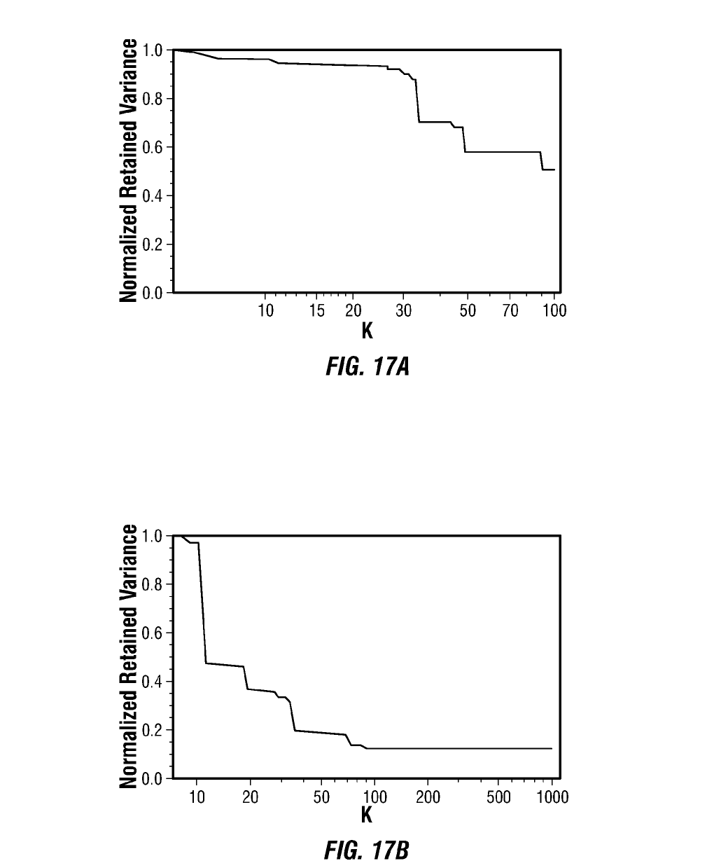

Graph metrics were considered in an effort to find one that is a robust indicator of the first occurrence of significant short circuiting with increasing K. Graph diameter was most consistently successful in guiding the selection of K for the 2D example point sets in this report. The diameter of a graph is defined as the maximum shortest path between all nodes in the graph. It is found by first using the Dijkstra shortest-path algorithm between all nodes in the graph, and then taking the maximum of these path lengths. Graph diameter monotonically decreases with increasing K because larger values of K provide additional graph paths, via the additional edges, while retaining all of the paths for smaller values of K. Short circuiting decreases the graph diameter, because the short-circuiting paths provide shorter routes between distant nodes on the graph. Thus we would expect the graph diameter to slowly decrease as K increases within the local-neighborhood regime, with a sharp decrease when short circuiting becomes significant. In order to provide a consistent measure of graph diameter versus K, the two graph nodes corresponding to the maximal shortest path are recorded for the K=K_{crit} case, and we define the graph diameter for all subsequent values of K as the shortest path length between these two nodes. In some embodiments, this is preferable to using the strict definition of graph diameter for all values of K because the presence of short circuiting forces the graph-diameter path to route around the short circuits. Plots of normalized graph diameter versus K are presented for the parabolic and spiral sample sets in FIGS. 17(a) and 17(b). Note that the first significant step decrease in normalized graph diameter is associated with the first occurrence of short circuiting. This suggests that normalized graph diameter might be a useful indicator of short circuiting. The optimal choice of K is thus the largest value of K before the first significant step decrease.

### IMAGE EXAMPLES

The kPCA algorithm is applied here to two large-scale cases in order to illustrate its robustness and effectiveness. Both are 10000-parameter problems on a 100x100 grid. The first case is not an ideal example for demonstrating the nonlinear capabilities of kPCA because the samples are drawn from a multinormal distribution, making PCA the ideal choice for dimension reduction. However, it is an interesting test of the robustness of IsoMap because it should be able to perform well in the limit of K=100, reducing kPCA to PCA. The second case treats 100 samples drawn from a distribution representing the positions and azimuths of four channels in each model. We show that PCA is poorly suited for dimension reduction in this case and that kPCA performs much better.

### Multinormal Distribution

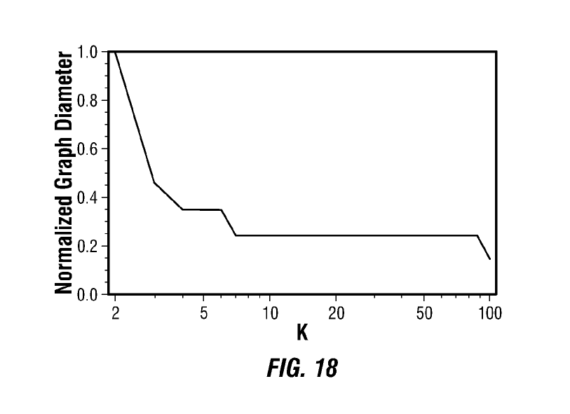

In this case, 100 samples are drawn from the multinormal distribution illustrated in FIG. 5. The normalized graph diameter versus K is plotted in FIG. 18. For this sample set, k_{crit}=2. Since these samples were drawn from a multinormal distribution, PCA is the correct approach to use for the determination of the latent variables. Consequently, the appropriate neighborhood choice for kPCA in this case is K=100. FIG. 18 indicates an abrupt decline in normalized graph diameter in stepping from K=2 to K=3. Applying lessons from the 2D examples, this seems to indicate short circuiting at K=3, which we know to be spurious in this case because the problem is known to be linear. Ignoring, for now, the K=2 value, the remaining points on the plot smoothly decline, indicating that K=100 is the best value.

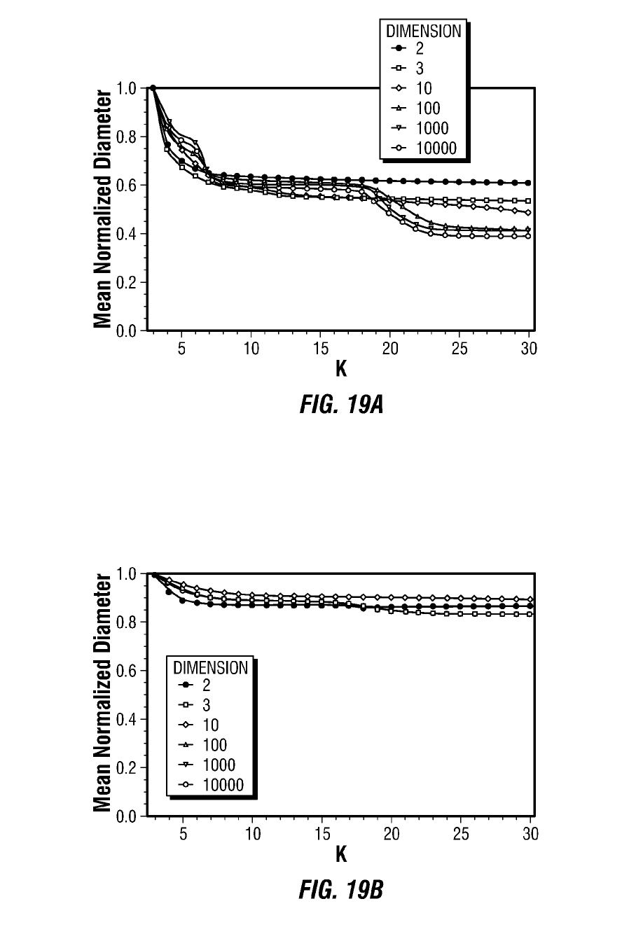

Here, we examine the cause of the rapid initial drop that is observed in the FIG. 18, but not present in either of the cases in FIG. 17. First consider the case of a random graph whose 100 nodes are drawn uniformly from a unit cube of dimension d and are connected with the K nearest neighbors. For each random draw of the 100 nodes, the normalized graph diameter is computed for K values 3-30. This is repeated for 100 realizations and a plot of the mean curve is presented. This is performed for unit cubes of several different spatial dimensions in the range 2-10000. These mean curves of diameter versus K are presented in FIG. 19(a). These curves consistently present a rapid drop in diameter for small K values over all spatial dimensions. At approximately K=10, the curves of all dimensions reach a plateau, with subsequent smaller drops and plateaus for the larger dimensions. The reason for the slower initial decline observed in FIGS. 17(a) and 17(b) for the parabolic and spiral models, respectively, is explored in FIG. 19(b), where the experiment of FIG. 19(a) was repeated with the first dimension of the unit cube expanded to a length of 10 in order to examine the effect of a long, narrow graph on the shape of the normalized graph diameter versus K. The moderated initial decline rate and the earlier attainment of the plateau match the behaviors observed in FIGS. 17(a) and 17(b) before the onset of short circuiting.

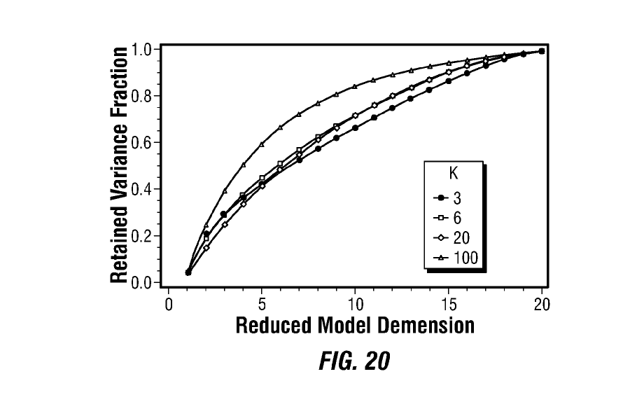

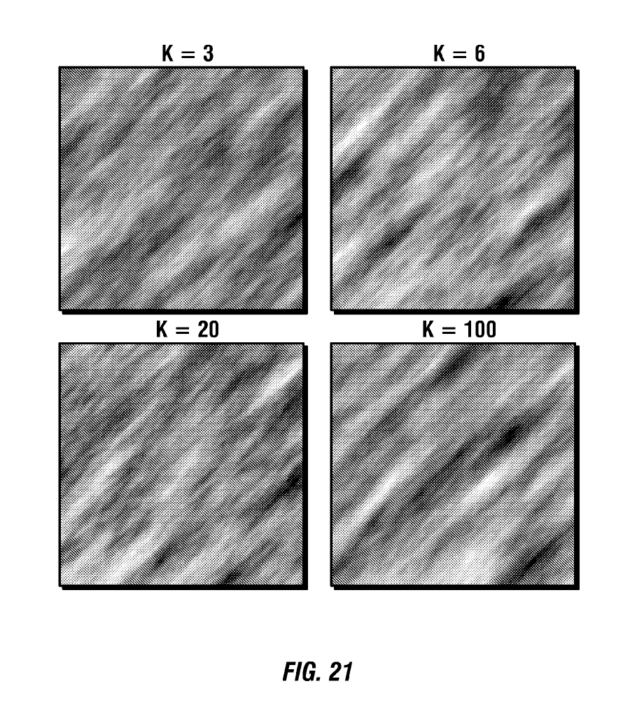

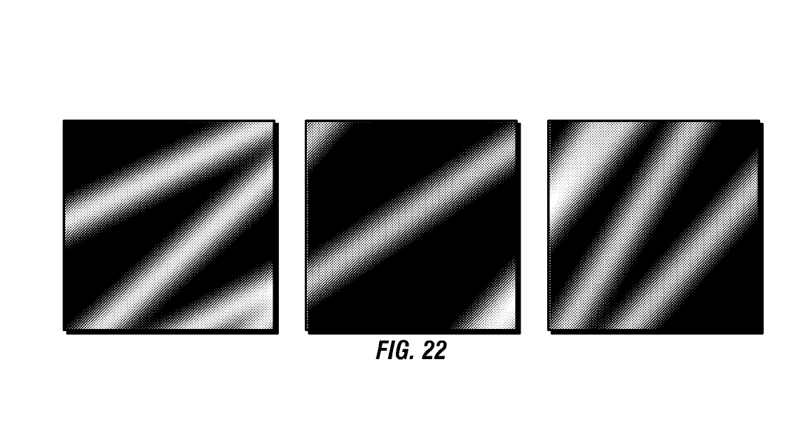

Next, we examine the consequences of misinterpreting the jumps in the normalized graph diameter plot (FIG. 18), and consequently select a value for K that is smaller than optimal. Retained variance fraction is plotted in FIG. 20 for four values of K, including K=100. The K=100 result was computed using the kPCA algorithm in order to demonstrate, by comparison with FIG. 5, that it yields results identical to those of PCA. The K=100 results possess higher retained variance fraction than the results for smaller values of K. That is, maximal retained variance is achieved when K=100. This reduction is to be expected since the latent coordinate system overfits the sample set when K is chosen too small, causing a reduction in variance as “noise” is modeled as “data”. The effect of undersizing K on models derived from a 50-dimensional latent space for different values of K is presented in FIG. 21. All of these models were generated from the same unit multinormal sample in the latent space. Comparison of the K=100 image against those with smaller, suboptimal values of K, indicates that while undersizing the neighborhood parameter preserves trends and scales, the images are consistently rougher than for the PCA (K=100) result and some features are lost.

### Channel Model

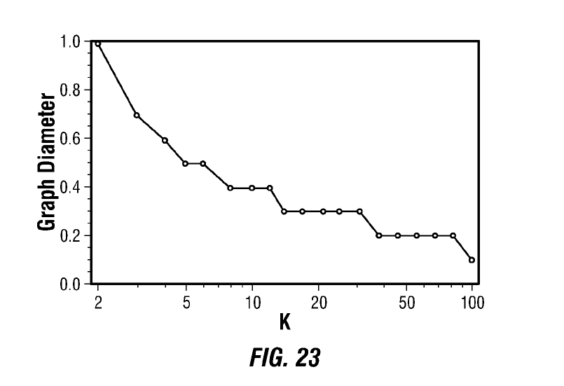

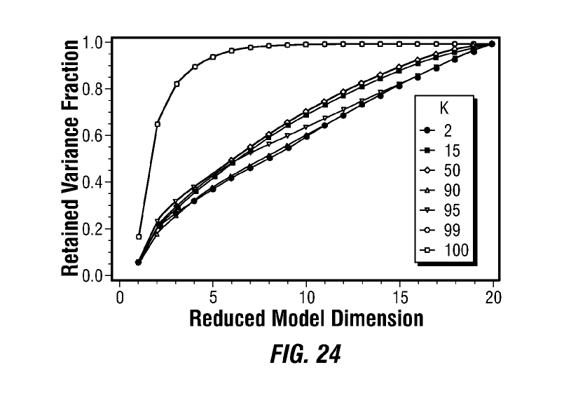

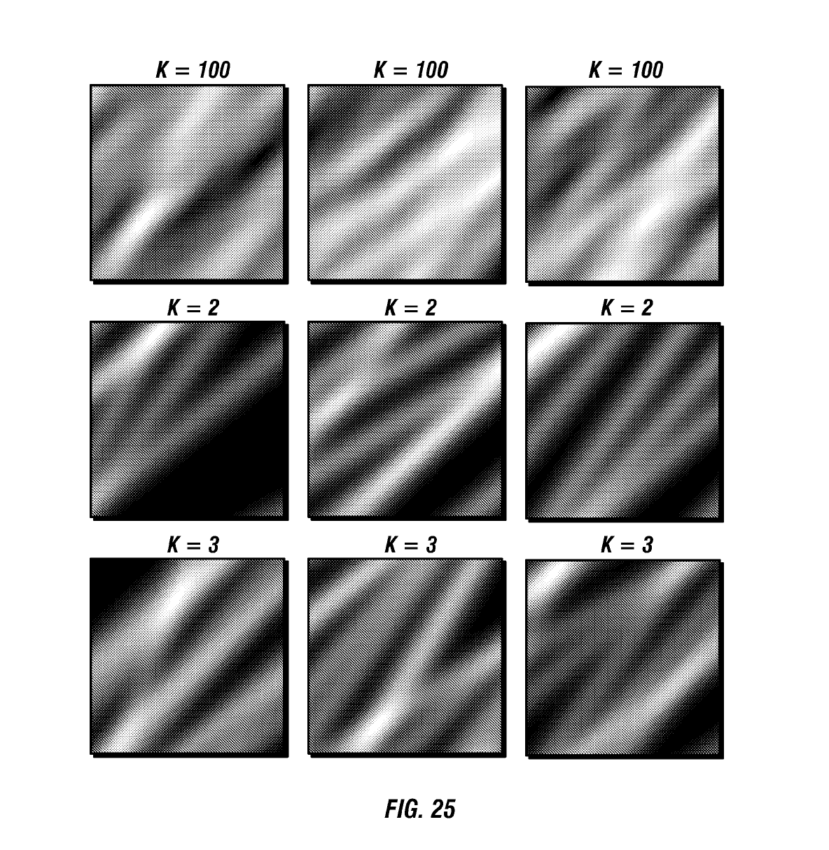

In this case, 100 samples are drawn from a distribution representing four linear channels, of Gaussian cross-section, whose azimuths are drawn from N(45°, 10°) and whose position is uniformly random. Three of these models are illustrated in FIG. 22. The model graph has K_{crit}=2. The normalized graph diameter versus K for these models, shown in FIG. 23, presents no evidence of short circuiting, suggesting that K=100 (PCA) is the best choice for dimension reduction. FIG. 24 provides the retained variance fraction versus K for the channel model. The PCA solution (K=100) converges to full variance retention with under 30 latent-variable dimensions. A plot of retained variance fraction for several values of K, shown in FIG. 24, demonstrates that PCA retains considerably more variance, for fixed model reduction, than kPCA for K<100. A demonstration of the inability of PCA to adequately model the channel case is illustrated in the top row of FIG. 25, where each image was generated by drawing a random sample from a unit multinormal in a 100-dimensional latent space and then mapping the result back into the model space. Although the azimuthal trends and feature widths are correctly portrayed, no individual channel features are apparent. The middle row of FIG. 25 illustrates the K =2 case; individual channels are easily observed. In the sample graph for K=2, each model is linked to only its two nearest neighbors, and in the pre-image problem, each latent-space sample is mapped back into the model space through a linear combination of its two nearest neighbors in latent space. This means that the K=2 results can only contain a maximum of eight channels. This pattern is reinforced in the bottom row of FIG. 25 for the K=3 case, where a maximum of 12 channels is possible. For this set of prior model samples, it seems that low values of K are best suited to representing the salient model features. The K=100 results are equivalent to PCA.

1. A method for hydrocarbon reservoir characterization and recovery, comprising:
collecting geological data relating to a subterranean formation;
forming initial parameters using the data;
performing a principal component analysis of the parameters to create a model; and
performing history matching using the model.

2. The method of claim 1, wherein the principal component analysis comprises a linear principal component analysis.

3. The method of claim 1, wherein the principal component analysis comprises a kernel principal component analysis.

4. The method of claim 1, wherein the performing the analysis comprises a reduced dimensional parameter space.

5. The method of claim 1, wherein the performing the history matching comprises an automated search of a feature space.

6. The method of claim 1, wherein performing history matching comprises using a gradient-based optimization algorithm.

7. The method of claim 1, wherein performing the principal component analysis of the parameters creates a set of latent variables that map onto initial model parameters.

8. The method of claim 1, further comprising introducing an oil field service to the formation.

9. The method of claim 8, wherein the service comprises reservoir management, drilling, completions, perforating, hydraulic fracturing, water-flooding, enhanced and unconventional hydrocarbon recovery, tertiary recovery, or a combination thereof.

10. A method for hydrocarbon reservoir characterization and recovery, comprising:
collecting geological data relating to a subterranean formation;
forming initial model parameters using the data;
performing a principal component analysis of the parameters to create a reduced set of latent variables to control the model;
performing history matching using the model, such that a history-matched model is generated; and
optimizing the history match to minimize mismatch of predicted versus measured data.

11. The method of claim 10, wherein the data comprises geology, well logs, and seismic information.

12. The method of claim 10, wherein the history matching comprises analyzing an uncertainty of the history-matched model.

13. The method of claim 12, wherein the principal component analysis comprises identifying the latent variables of the uncertainty.

14. The method of claim 13, wherein optimization occurs in a reduced control parameter space than if no principal component analysis occurred.

15. The method of claim 10, wherein the principal component analysis comprises a linear principal component analysis.

16. The method of claim 10, wherein the principal component analysis comprises a kernel principal component analysis.

17. The method of claim 10, wherein performing history matching comprises using a gradient-based optimization algorithm.

18. The method of claim 10, wherein the principal component analysis of the parameters creates a model that maps latent variables to the initial model parameters.

19. The method of claim 10, further comprising introducing an oil field service to the formation.

20. The method of claim 19, wherein the service comprises reservoir management, drilling, completions, perforating, hydraulic fracturing, water-flooding enhanced and unconventional hydrocarbon recovery, tertiary recovery, or a combination thereof.
